(19) United States
(12) Patent Application Publication
(10) Pub. No.: US 2025/0103822 A1
(43) Pub. Date: Mar. 27, 2025

(54) GENERATIVE ARTIFICIAL INTELLIGENCE POWERED RESPONSE GENERATION, VALIDATION, AND AUGMENTATION

(71) Applicant: Adobe Inc., San Jose, CA (US)

(72) Inventors: Niranjan Kumbi, Pleasanton, CA (US); Sreekanth Reddy, Bangalore (IN); Sumit Bhatia, Delhi (IN); Milan Aggarwal, Delhi (IN); Simra Shahid, Uttar Pradesh (IN); Nikitha Srikanth, Mysore (IN); Camille Girabawe, San Francisco, CA (US); Narayanan Seshadri, Pleasanton, CA (US)

(21) Appl. No.: 18/372,462

(22) Filed: Sep. 25, 2023

(51) Int. Cl. G06F 40/35

(52) U.S. Cl. CPC G06F 40/35

(57) ABSTRACT

System and methods for generating, validating, and augmenting question-answer pairs using generative AI are provided. An online interaction server accesses a set of digital content available at a set of designated network locations. The online interaction server further trains a pre-trained large language model (LLM) using the set of digital content to obtain a customized LLM. The online interaction server generates a set of question-answer pairs based on the set of digital content using the customized LLM and validates the set of question-answer pairs by determining if an answer in a question-answer pair is derived from the set of digital content. The online interaction server also selects a digital asset to augment an answer in a validated question-answer pair based on a semantic similarity between the validated question-answer pair and the digital asset.

### TECHNICAL FIELD

This disclosure relates generally to generative artificial intelligence (AI). More specifically, but not by way of limitation, this disclosure relates to generative AI-powered response generation, validation, and augmentation.

### BACKGROUND

Conversational systems, for examples chatbots, have been used on websites. These conversational systems are typically developed to qualify and generate leads and route leads to the right direction on the websites or in corresponding organizations. The conversational systems also provide an interactive search function to website visitors and answer questions from the website visitors. The conversational system may identify a visitor's intent and guide the visitor to certain web pages, where the visitor may find some information that the visitor is looking for. For example, through a series of interactions between a website visitor and a chatbot on the website, the chatbot can infer that the website visitor wants to find information about a certain product or service and the chatbot can then provide a link to the product or service on the website.

### SUMMARY

Certain embodiments involve generative AI-powered response generation, validation, and augmentation. In one example, an online interaction server receives a user question via a client device. The online interaction server estimates a semantic similarity between the user question and each question in a set of validated question-answer pairs to generate a set of semantic similarity scores. If the highest semantic similarity score in the set of semantic similarity scores is greater than a threshold value, the answer paired with a predefined question corresponding to the highest semantic similarity score is displayed via the client device. The online interaction server also selects a digital asset to augment the answer using a semantic search algorithm. The digital asset is displayed along with the answer.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment in which an online interaction server generates, validates, and augment responses, according to certain embodiments of the present disclosure.

FIG. 2 depicts an example of a process for generating question-answer pairs for an online platform, according to certain embodiments of the present disclosure.

FIG. 3 depicts an example of a process for automatically responding to a user question, according to certain embodiments of the present disclosure.

FIG. 4 depicts an example of a GUI displaying a set of question-answer pairs generated for an online platform, according to certain embodiments of the present disclosure.

FIG. 5 depicts an example of a GUI displaying a set of prompt selections for generating question-answer pairs for an online platform, according to certain embodiments of the present disclosure.

FIG. 6 depicts an example of a GUI for generating questions and answers from a set of digital content, according to certain embodiments of the present disclosure.

FIG. 7 depicts an example of a GUI for responding to a user question, according to certain embodiments of the present disclosure.

FIG. 8 depicts an example of a computing system for implementing certain embodiments of the present disclosure.

### DETAILED DESCRIPTION

The present disclosure provides techniques for automatically generating, validating, and augmenting responses to user questions using generative AI. Traditionally, the process of writing conversation flows and scripts to interact with website visitors is mostly manual, with very little automation. It can take weeks to anticipate the various potential needs of incoming website visitors, and create corresponding questions, answers, follow up questions, and conversation workflows that can be used by a conversational system for a website (e.g., a chatbot) to interact with website visitors. Meanwhile, because the conversation flows are scripted and do not change dynamically based on the response of the website visitor, the website visitor is often offered a series of options to choose from with none of the options meeting the visitor's particular need. From the visitor's perspective, the conversational system is artificial and cumbersome, which degrades the overall visitor experience. From the website provider's perspective, the degraded visitor experience results in poor engagement and negatively affects the performance of the website and associated entities.

Foundation models (FMs) or large language models (LLMs) can synthesize large amounts of information available on the website and provide succinct responses in natural language form to visitors' questions. This saves visitors time and effort to navigate to various places on the website to find the information they are looking for and greatly improves the user experience. However, current conversational systems built using LLM fall short of assisting websites and associated entities. This is because LLMs are prone to hallucination-making up text that is grammatically correct and fluent but is factually incorrect. Moreover, while typical LLM-based solutions can provide answers to visitors' questions, they do not necessarily engage the visitors to spend more time on the website. Typically, websites and associated entities want to provide the visitors with relevant follow-up material (e.g., relevant case studies, white papers, etc.) so the visitors spend more time on the website and product-related content, which ultimately can lead to a formal engagement. Thus, in addition to providing answers to visitor questions, an effective solution needs to provide the visitors with relevant follow-up material as well.

In an embodiment of the present disclosure, an online interaction system can automatically provide a set of predefined questions and answers for an entity (e.g., a website or an organization associated with the website). The online interaction system fine-tunes a pre-trained LLM using a set of digital content from the entity. The fine-tuned LLM can be prompted to generate a set of questions and answers based on the set of digital content from the entity. The set of questions and answers can be validated using a textual entailment model to ensure that the answers corresponding to the questions are accurately derived from the set of digital content. A digital asset (e.g., case studies, white papers, etc.) may also be identified to provide additional information associated with an answer corresponding to a question. The validated questions and answers are stored in the online interaction system as predefined question-answer pairs. Upon receiving a user question from a client device, the online interaction system identifies a predefined question from the predefined question-answer pairs that best matches the user question. The predefined answer corresponding to the predefined question that best matches the user question is displayed on the client device. A link to a digital asset that provides additional information can also be provided along with the predefined answer.

The following non-limiting example is provided to introduce certain embodiments. In this example, an online interaction server communicates with an online platform over a network. The content generation system accesses a set of digital content associated with the online platform available at a set of designated network locations, for example Uniform Resource Locator (URL) linked contents from a website associated with an entity. The online interaction server also has access to a pre-trained LLM. The online interaction server further trains the pre-trained LLM using the digital content specific to the online platform. An operator associated with the online platform can provide a prompt to the fine-turned LLM to generate a set of question-answer pairs based on the set of digital content.

The online interaction server validates (e.g., fact-checks) the set of question-answer pairs by determining that the answers in the question-answer pairs are accurately derived from the set of digital content provided by the online platform. For example, a textual entailment model can be used to determine an entailment score for an answer in a question-answer pair. The set of digital content is considered as a premise and the answer to be validated is considered as a hypothesis. The textual entailment model determines whether the answer (hypothesis) can be inferred from the set of digital content (premise) by calculating an entailment score. If the entailment score is equal to or greater than a threshold entailment score, then the answer is validated. The online interaction server keeps the corresponding question-answer pair. If the entailment score is less than the threshold entailment score, the question-answer pair is discarded.

The validated question-answer pairs may be transmitted to a reviewer associated with the online platform for review and approval. The online interaction server can further update the validated question-answer pairs based on the feedback from the reviewer associated with the online platform. Alternatively, the reviewer can update the validated question-answer pairs during review. The validated question-answer pairs that are approved by the receiver are stored as predefined questions and answers, which can be used by the online platform for responding to user questions.

The online interaction server can also select a digital asset (e.g., a digital file or a link of the digital file) that matches an answer in a question-answer pair to provide additional information along with the answer. The digital asset can be from the set of digital content initially provided by the online platform. Alternatively, or additionally, the digital asset can be selected from a set of digital assets further provided by the online platform, such as case studies, whitepapers, webinars, etc. A semantic search algorithm can be implemented to find a digital asset that matches an answer in a question-answer pair. For example, an embedding model is used to generate an embedding vector for the question-answer pair and an embedding vector for the content in each digital asset of the digital assets further provided by the online platform. A similarity score can be estimated to measure the similarity between the embedding vector of the question-answer pair and the embedding vector for the content of each digital asset. The set of digital assets can be ranked based respective similarity scores. One or more digital assets with a greater similarity score than other digital assets can be selected to augment the answer in the question-answer pair.

Upon receiving a user question from a client device, the online interaction server identifies a predefine question that best matches the user question. For example, the online interaction server can generate an embedding vector for the user question and an embedding vector for the predefined questions stored on the online interaction server. The online interaction server can estimate a similarity score to measure the similarity between the embedding vector for the user question and the embedding vector for each predefined question. If the highest similarity score corresponding to a predefined question is greater than a predetermined threshold, the predefine answer corresponding to the predefined question is used to respond to the user question. A digital file may also be identified along with the predefined answer to provide additional information, as described in the paragraph above. A link to the digital file can be provided along with the predefined answer. The digital file can be identified beforehand for a predefined question-answer pair. Alternatively, or additionally, the digital file can be identified after receiving the user question.

If the highest similarity score is less than the predetermined threshold, the online interaction server generates a message to the client device indicating that a responsive answer to the user question is not found. The user associated with the client device may be directed to a representative associated with the online platform for more information.

Certain embodiments of the present disclosure overcome the disadvantages of the prior art, by automatically providing validated and augmented responses via an online interaction server. The online interaction server automatically generates predefined questions and answers using large language models (LLMs) so that an entity does not need to manually create and update the corpus of questions and answers. The LLMs are fine-tuned with digital content provided by the entity so that the predefined questions and answers generated by the LLMs are aligned with the style of the digital content specific to the entity. Further, the predefined questions and answers are validated by a textual entailment model to prevent incorrect responses to user questions. The automatic validation also reduces the amount of time an entity has to spend on reviewing and approving the LLM-generated questions and answers. Moreover, additional information such as relevant analytics, cases, or webinars can be provided via URL links along with a predefined answer corresponding to a predefined question that best matches to a user question. The additional information can further user engagement with the entity. Overall, the proposed online interaction server improves automatic responses to user queries by automatically generating and validating predefined questions and answers and providing relevant additional information.

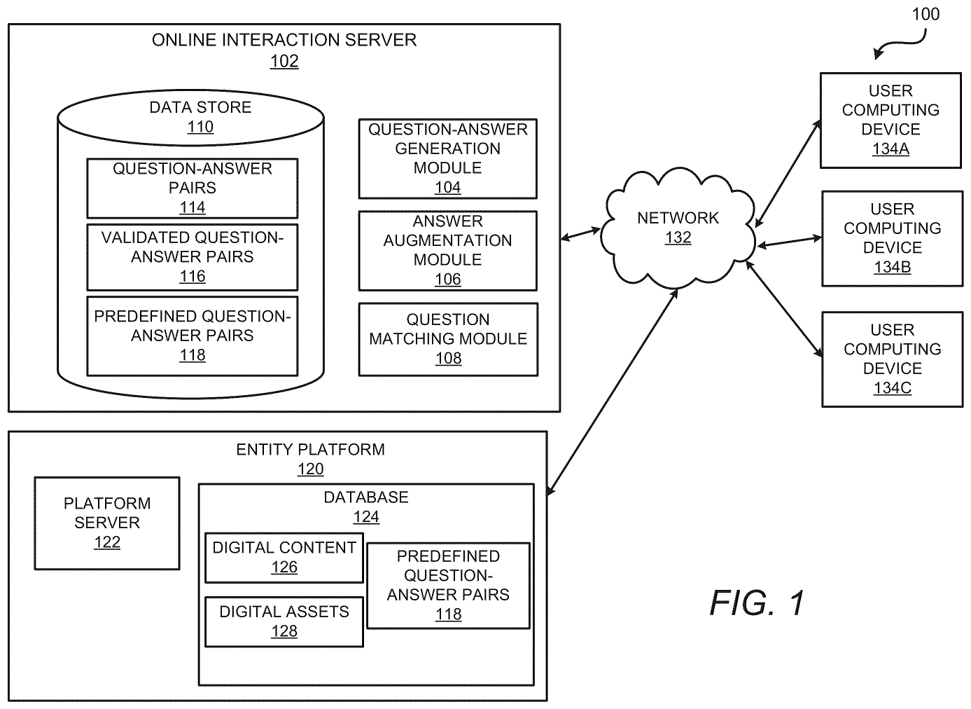

Referring now to the drawings, FIG. 1 depicts an example of a computing environment 100 in which an online interaction server 102 generates, validates, and augment responses, according to certain embodiments of the present disclosure. In various embodiments, the computing environment 100 includes an online interaction server 102 connected with an online platform 120 and user computing devices 134A, 134B, and 134C (which may be referred to herein individually as a user computing device 134 or collectively as the user computing devices 134) via a network 132. A user computing device 134 can be a desktop computer, a laptop computer, a tablet, a smart phone, or any suitable computing device. The network 132 may be a local-area network (“LAN”), a wide-area network (“WAN”), the Internet, or any other networking topology known in the art that connects the user computing device 134 to the online interaction server 102 or the online platform 120.

The online platform 120 includes a platform server 122 and a database 124. Examples of the online platform 120 can include a website for an entity offering certain products or services, or any other online platform that provides products or services. The online platform 120 herein is described for purposes of illustration only and the platform does not necessarily need to be online. The database 124 stores digital content 126, digital assets 128, and predefined question-answer pairs 130. The digital content 126 can be related to the product or service provided by the online platform 120. The digital content 126 can be used for generating question-answer pairs by the online interaction server 102. The digital assets 128 can be part of or different from the digital content 126. The digital assets 128 are used for augmenting answers in question-answer pairs to provide additional information. The predefined question-answer pairs 130 are generated by the online interaction server 102 and can be used for answering user questions from a user computing device 134.

The online interaction server 102 includes a question-answer generation module 104, answer augmentation module 106, a question matching module 108, and a data store 110. The question-answer generation module 104 is configured to generate a set of question-answer pairs using a set of digital content 126 from the online platform 120. The question-answer generation module 104 can implement a pre-trained LLM to generate the set of question-answer pairs. The pre-trained LLM can be fine-tuned with the digital content 126 from the online platform 120 before generating the question-answer pairs so that the questions and answers generated by the LLM are aligned with the style of the digital content 126. The operator associated with the online platform 120 can also provide a prompt to the fine-tuned pre-trained LLM for generating question-answer pairs.

The question-answer generation module 104 is also configured to validate the generated question-answer pairs by determining that an answer in a question-answer pair is derived from the digital content 126. The question-answer generation module 104 can implement a textual entailment model for validation. The textual entailment model determines an entailment score for the answer in the question-answer pair. The digital content is considered as a premise and the answer in the question-answer pair is considered as a hypothesis. The textual entailment model determines whether the answer (hypothesis) can be inferred from the set of digital content (premise) by calculating an entailment score. If the entailment score is equal to or greater than a threshold entailment score, the answer is validated, and the question-answer pair is kept. If the entailment score is less than the threshold entailment score, the question-answer pair is discarded.

The question-answer generation module 104 is also configured to transmit the validated question-answer pairs to the online platform 120 for review. An operator associated with the online platform 120 may provide feedback to question-answer generation module 104 about the validated question-answer pairs or modify the validated question-answer pairs. The reviewed and approved question-answer pairs are stored as predefined question-answer pairs 118 in the database 124 of the online platform 120.

The answer augmentation module 106 is configured to augment an answer in a question-answer pair by matching one or more digital files or other digital assets to the answer in the question-answer pair for providing additional information. For example, the answer augmentation module 106 can implement an embedding model to generate an embedding vector for each digital asset of a set of digital assets 128 provided by the online platform 120 and an embedding vector for the question-answer pair. The answer augmentation module 106 can implement a similarity model to measure a similarity between the embedding vector for the validated question-answer pair and the embedding vector for each digital asset by estimating a similarity score. The answer augmentation module 106 can select one or more digital assets having a greater similarity score than other digital assets to provide additional information beside the generated answer. In some examples, the answer augmentation module 106 identifies the one or more digital assets for an answer in a question-answer pair after the question-answer pairs is validated or approved. In some examples, the answer augmentation module 106 identifies the one or more digital assets for an answer in a question-answer pair when the corresponding question is identified to match a user question.

The question matching module 108 is configured to match a user question to a question in the predefined question-answer pairs 118 for the online platform. A user computing device 134 visiting the online platform 120 can transmit a user question via the online platform 120 to the online interaction server 102. In some examples, the question matching module 108 on the online interaction server 102 implements an embedding model to generate an embedding vector for the user question and an embedding vector for each question in the predefined question-answer pairs 118. The question matching module 108 then implements a similarity model to measure a similarity between the embedding vector for the user question and the embedding vector for each question in the predefined question-answer pairs to identify a question that best matches the user question.

The data store 110 is configured to store data processed or generated by the online interaction server 102. Examples of data stored in the data store 110 includes question-answer pairs 114 generated by an LLM model in the question-answer generation module 104, validated question-answer pairs 116, and predefined question-answer pairs 118 approved by the online platform 120. The data store 110 can also store digital content 126 and digital assets 128 from the online platform. In addition, the data store 110 can store some data generated in the processing of generating, validating, augmenting, or matching question-answer pairs. For examples, embedding vectors for digital assets, embedding vectors for predefined question-answer pairs, similarity scores, etc.

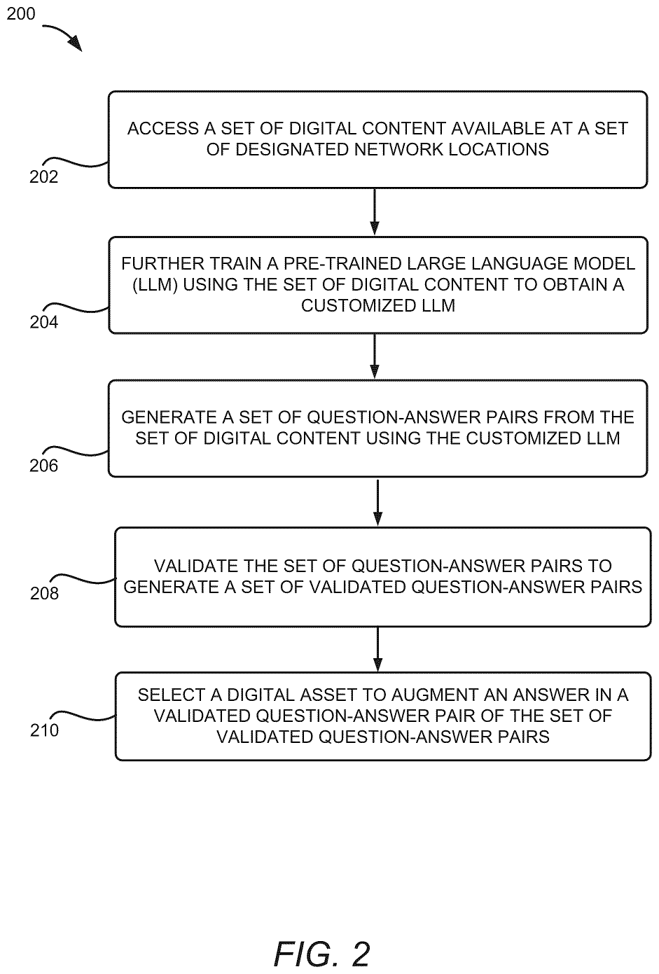

FIG. 2 depicts an example of a process 200 for generating question-answer pairs for an online platform 120, according to certain embodiments of the present disclosure. At block 202, an online interaction server 102 accesses a set of digital content 126 available at a set of designated network locations. The set of digital content 126 is provided by the online platform 120 and is specific about the online platform 120. The set of digital content 126 can include webpage content, enterprise documents, and any other digital files provided by the online platform. The set of digital content 126 is available at designated network locations in a database 124 on the online platform 120 or in a cloud-based database. The designated network locations can be represented by URL links.

At block 204, the online interaction server 102 further trains a pre-trained LLM using the set of digital content to obtain a customized LLM. The online interaction server 102 can implement a pre-trained LLM in the question-answer generation module 104 for generating question-answer pairs based on the digital content for an online platform. The pre-trained LLM can be a Generative Pre-training Transformer (GPT), Text-To-Text Transfer Transformer (T5), an Open Pre-trained Transformer (OPT), a Bidirectional Auto-Regressive Transformer (BART), or any variations thereof. The LLM is typically pre-trained on a large web-scale text data on a simple pre-training task which does not require explicit annotated labels. This enables the LLM to learn generalized representations of text, gather world knowledge, and develop generative capability. The online interaction server 102 further trains the pre-trained LLM on the set of digital content 126 specific to the online platform 120 using the same task as used in the pre-training to obtain a customized LLM for the online platform 120 so that the output (e.g., generated questions and answers) are aligned with the tone and language in the set of digital content 126.

At block 206, the online interaction server 102 generates a set of question-answer pairs 114 from the set of digital content using the customized LLM. In some examples, the online platform 120 provides a prompt (e.g., instruction) to customized LLM in the question-answer generation module 104 of the online interaction server 102. For example, the prompt is “generate m questions and corresponding answers in the format—Question:; Answer:.” The customized LLM then generates a set of question-answer pairs 114 from the set of digital content 126 for the online platform 120 based on the prompt. Functions included in block 206 can be used to implement a step for generating a set of question-answer pairs based on the set of digital content.

In some examples, the question-answer generation module 104 requests a second set of digital content, for example, webinars, case studies, blogs, or any other content that contains information about customer stories, challenges involved, solutions adopted, and results. The question-answer generation module 104 generates follow-up questions and answers based on the second set of content and the question-answer pairs generated initially.

At block 208, the online interaction server 102 validates the set of question-answer pairs to generate a set of validated question-answer pairs 116. The question-answer generation module 104 can automatically determine if the set of question-answer pairs 114 are generated from the set of digital content 126. Pre-trained LLMs may be prone to hallucination-making up grammatically correct and fluent text but factually incorrect. Thus, even an LLM customized for an online platform 120 may generate some answers based on the background world knowledge the LLM gathered during pre-training instead of based on the digital content 126 from the online platform 120 solely. The question-answer generation module 104 can verify that an answer in a given question-answer pair is derived using the digital content from the online platform 120 and detect and filter answers that are not. In some examples, the question-answer generation module 104 implements a natural language processing (NLP)-based textual entailment model. The textual entailment model takes the digital content 126 as a premise and an answer in a question-answer pair as a hypothesis to determine whether the answer can be inferred from the digital content 126 or not by calculating an entailment score. If the entailment score is equal to or greater than a threshold entailment score, then the answer is validated, and the corresponding question-answer pair is a validated question-answer pair. If the entailment score is less than the threshold entailment score, then the answer is not validated, and the corresponding question-answer pair is discarded. The entailment score is a probability that the answer is inferred from the digital content. The threshold entailment score is adjustable by the online platform 120.

The entailment score corresponding to a question-answer pair can be considered as a validity likelihood level. In some examples, the validated question-answer pairs are ranked based on their validity likelihood. The validated question-answer pairs 116 can be transmitted to the online platform 120 for review, edit, and approval by an operator of the online platform 120. The validated question-answer pairs ranked by validity likelihood can make the review more efficient.

The online platform 120 may request the question-answer generation module 104 to generate more question-answer pairs based on the digital content 126. The online platform 120 may also update digital content 126 and request the question-answer generation module 104 to regenerate the question-answer pairs 114. The approved question-answer pairs by the online platform 120 become predefined question-answer pairs 118 that will be used for answering user questions. In some examples, an operator of the online platform 120 manually adds curated question-answer pairs to the predefined question-answer pairs to enrich the predefined question-answer pairs on the online platform 120.

In some examples, the question-answer generation module 104 of the online interaction server 102 periodically check the digital content 126 on the online platform 120 to update the question-answer pairs. Alternatively, or additionally, the question-answer generation module 104 of the online interaction server 102 the online platform updates the predefined question-answer pairs 118 on demand upon requests from the online platform 120.

At block 210, the online interaction server 102 selects a digital asset to augment an answer in a validated question-answer pair of the set of validated question-answer pairs 116. For a validated question-answer pair, an answer augmentation module 106 on the online interaction server 102 can augment the answer with additional relevant information to improve engagement when the answer is used for responding a user question. The additional information can be provided via a link (e.g., URL link). The additional information makes it easier for a user to find other related information relevant to the user question. The answer augmentation module 106 selects one or more digital assets (e.g., digital file or corresponding links) from a set of digital assets 128 to augment the answer with additional information. The set of digital assets 128 can include webinars, case studies, blogs, whitepapers, etc. The set of digital assets 128 can be part of the set of digital content 126 provided for generating the question-answer pairs. Alternatively, or additionally, the set of digital assets 128 can be different from the set of digital content 126 provided for generating the question-answer pairs 114. In some examples, the answer augmentation module 106 augments answers in predefined question-answer pairs 118 which are reviewed and approved by the online platform 120.

The answer augmentation module 106 can estimate a semantic similarity score using a similarity model to measure a similarity between a digital asset and a question-answer pair, rank the set of digital assets based on respective similarity scores, and select one or more digital assets with greater similarity scores than other digital scores. In some examples, the answer augmentation module 106 determines an embedding vector for each digital asset in a set of digital assets 128 using an embedding model. The content in the set of digital assets 128 is denoted as C=[C₁, C₂, . . . , Cₙ]. The embedding vector for the content of a digital asset is eₐₛₛₑₜ₋ᵢ=M_{embedding}(Cᵢ). The answer augmentation module 106 also determines an embedding vector for a question-answer pair. The answer string can be concatenated after the question string as input to the embedding model. The embedding vector for the question-answer pair is represented by e_{[q;a]-j}=M_{embedding}(qⱼ+aⱼ), where + is a string concatenation operation. In some examples, the answer augmentation module 106 estimates a cosine similarity between eₐₛₛₑₜ₋ᵢ and e_{[q;a]-j} as shown in Equation (1), where · denotes the dot product operation between two embedding vectors, and ∥ denotes the L-2 norm of the embedding vector.

$$cosine similarity = \frac{{e}_{asset - i} \cdot {e}_{[ q ; a ] - j}}{\vert {e}_{asset - i} \vert \vert {e}_{[ q ; a ] - j} \vert} \qquad ( 1 )$$

The digital assets are ranked based on their cosine similarity with a question-answer pair. The top K (e.g., one, two, or three) most matching digital assets based on the ranking are selected to augment the answer in the question-answer pair. For example, a URL link to additional information is appended to the answer in the question-answer pair. This way, additional relevant content related to the question-answer pair is shown to user when the user asks a question similar to a question in the question-answer pair. Functions included in block 210 can be used to implement a step for selecting a digital asset to augment the answer in a validated question-answer pair based on a semantic similarity between the validated question-answer pair and the digital asset.

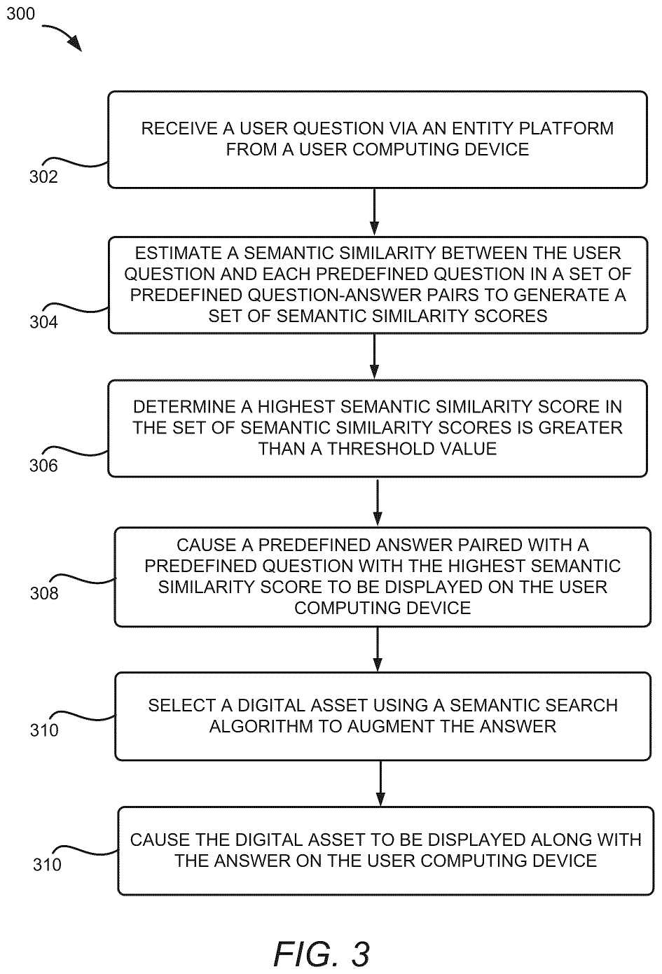

FIG. 3 depicts an example of a process 300 for automatically responding to a user question, according to certain embodiments of the present disclosure. At block 302, an online interaction server 102 receives a user question via an online platform 120 from a user computing device 134. The online platform 120 can be a website associated with an entity. A user can visit the website via a user computing device 134, such as a desktop computer, a laptop computer, a tablet, or a smart phone. The website may include graphical user interface (GUI) to interact with a conversational system (e.g., chatbot) provided by an online interaction server 102. The user can type a user question in the conversational system via the GUI on the website.

At block 304, the online interaction server 102 estimates a semantic similarity between the user question and each predefined question in a set of predefined question-answer pairs 118 to generate a set of semantic similarity scores. The online interaction server 102 stores or accesses a set of predefined question-answer pairs 118 as generated, validated, and approved at blocks 206 and 208 in FIG. 2 as described above. A question matching module 108 on the online interaction server 102 can estimate a semantic similarity between the user question and a predefined question in the set of predefined question-answer pairs 118. In some examples, the question matching module 108 generates an embedding vector for the user question and an embedding vector for each predefined question in the set of predefined question-answer pairs 118 using an embedding model. The question matching module 108 then estimates a semantic similarity score to measure a similarity between the embedding vector for the user question and the embedding vector for each predefined question in the set of predefined question-answer pairs. In some examples, the question matching module 108 estimates a cosine similarity between the embedding vector of the user question and the embedding vector for each predefined question in the set of predefined question-answer pairs 118 using an equation similar to Equation (1).

At block 306, the online interaction server 102 determines whether a highest semantic similarity score in the set of semantic similarity scores is greater than a threshold value. A predefined question with the highest semantic similarity score is considered as the best match from the set of predefined question-answer pairs for the user question. The threshold value is adjustable by the online platform based on its accuracy requirements for responding user questions. If the highest semantic similarity score is less than the threshold value, the online interaction server 102 automatically transmits a message to the user computing device 134 indicating that a responsive answer to the user question is not found. The online interaction server 102 may also provide an option for the user to be connected with an operator associated with online platform 120 to answer the user question. If the user selects that option, the user computing device 134 can be routed to a human agent on the online platform 120. If the user interacts with a human agent, the online interaction server 102 can transmit the predefined answer to the predefined question with the highest semantic similarity score to the human agent. The human agent may use the predefined answer as a reference when responding to the user question. In some examples, the user question answered by the human agent can be added to the set of predefined question-answer pairs together with the answer from the human agent to enrich the set of predefined question-answer pairs.

At block 308, the online interaction server 102 causes a predefined answer paired with a predefined question with the highest semantic similarity score to be displayed on the user computing device 134 in response to determining that the highest semantic similarity score is equal to or greater than the threshold value. If the highest semantic similarity score is equal to or greater than the threshold value, the online interaction server 102 transmits the predefined answer to the user computing device 134. The predefined answer can be displayed following the user question in the GUI of a conversational system on an online platform 120 (e.g., a website) via the user computing device 134.

At block 310, the online interaction server 102 selects a digital asset using a semantic search algorithm to augment the predefined answer. The interaction server can select the digital asset that matches the answer for providing additional information similar to block 210 in FIG. 2 as described above. The digital asset for augmenting a predefined answer can be selected after the predefined answer is generated during a creation phase as illustrated in FIG. 3. Alternatively, the digital asset for augmenting a predefined answer can be determined when the corresponding predefined question is selected to match the user question the best. One or more digital assets can be selected to augment the answer.

At block 312, the online interaction server 102 causes the digital asset to be displayed along with the answer on the user computing device 134. The digital asset can be displayed following the predefined answer in the GUI of a conversational system on an online platform 120. In some examples, the digital asset is displayed as a URL link to a digital file, such as a webinar, a case study, or a white paper.

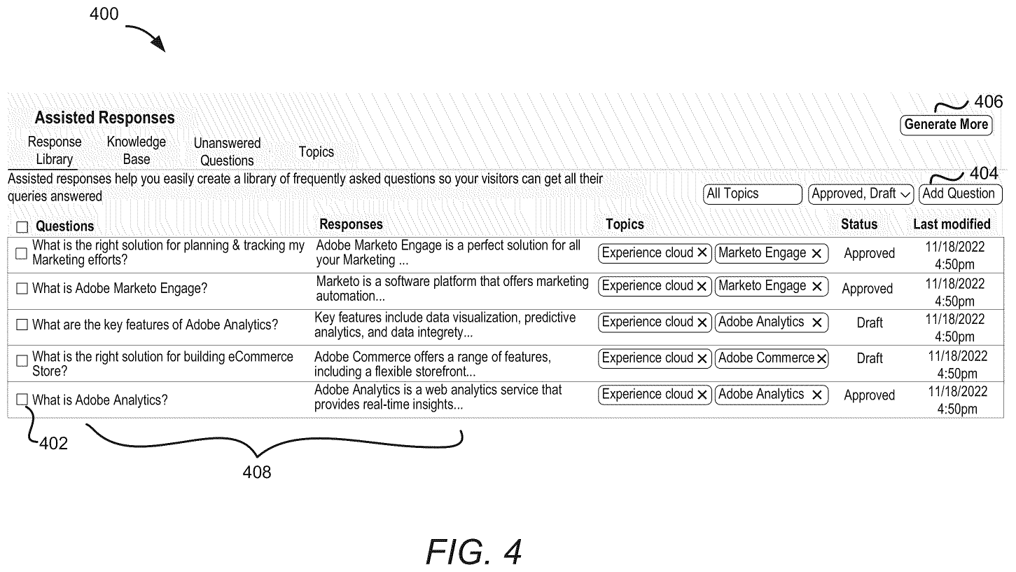

FIG. 4 depicts an example of a GUI 400 displaying a set of question-answer pairs 408 generated for an online platform 120, according to certain embodiments of the present disclosure. The GUI 400 provides a set of question-answer pairs 408 to a reviewer associated with the online platform. The GUI 400 also displays one or more associated topics, the status, and last modified time for each question-answer pair. The reviewer can select a question-answer pair for edit or approval by checking a box 402 in front of a question. The reviewer can also manually add a question-answer pair by click an “add question” button 404. In addition, the GUI 400 also provides a button 406 for generating more question-answer pairs. When a reviewer clicks or touches the button 406, it triggers the online interaction server 102 to generate more question-answer pairs based on the digital content 126 provided by the online platform 120.

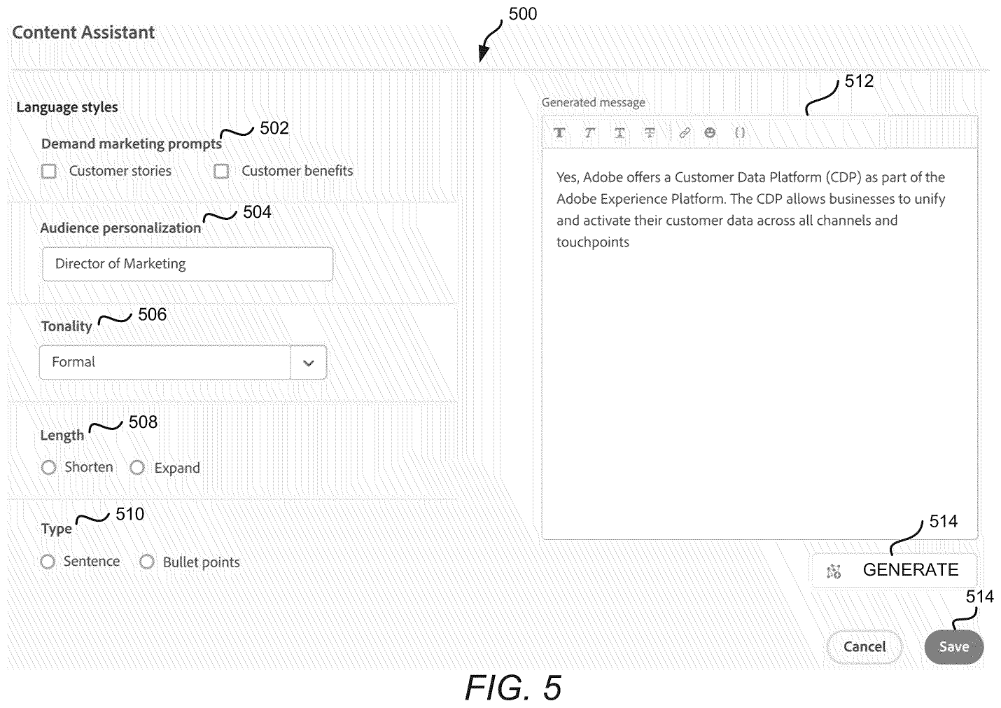

FIG. 5 depicts an example of a GUI 500 displaying a set of options for editing an answer 512 in a question-answer pair, according to certain embodiments of the present disclosure. An operator associated with an online platform 120 can interact with an online interaction server 102 via GUI 500 to update certain language styles about an answer 512. These specified language styles are used as prompts to the customized LLM model for updating the answer 512. For example, an operator associated with the online platform can provide demand marketing prompts 502 so that a generated answer includes the specified marketing content (e.g., customer stories or customer benefits) to generate demand. The operator can also define the audience personalization 504, for example, the answer is generated for directors of marketing. The operator can also define the tonality 506, for example, the answer is in a formal tone. The operator can also specify the length of the answer, for example shortened or expanded. The operator can also specify the type of the answer, for example, sentence answers, or bullet points. Once the language styles (e.g., 502, 504, 506, or 508) are updated, the user can press a “generate” button 514 to regenerate the answer based on the updated language styles. When the operator approves the answer, the operator can click or press a “save” button.

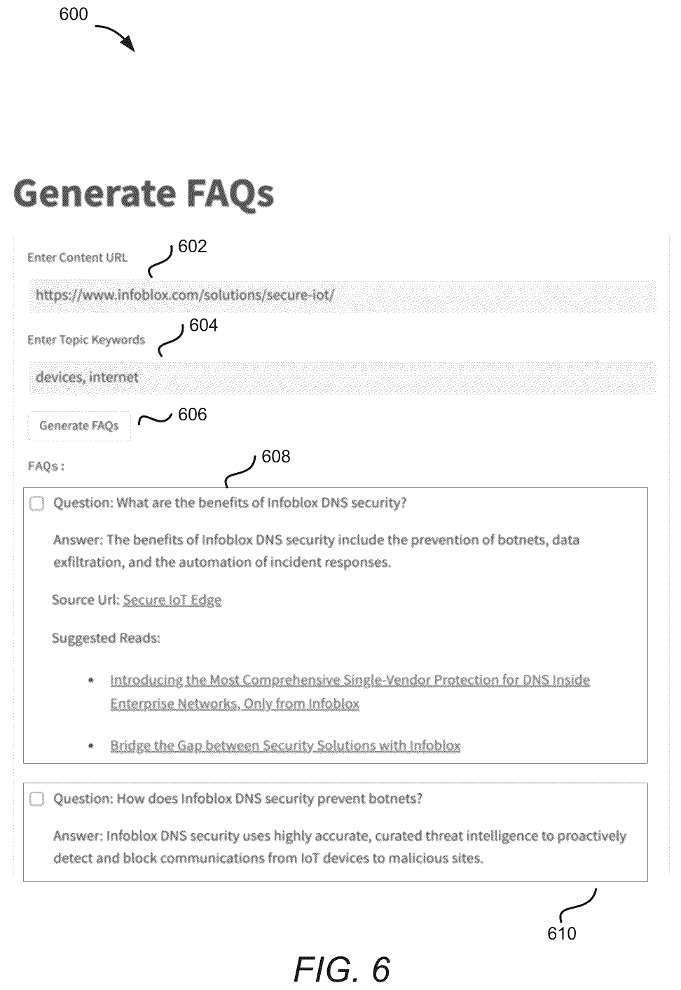

FIG. 6 depicts an example of a GUI 600 for generating questions and answers from a set of digital content, according to certain embodiments of the present disclosure. An operator associated with an online platform can provide digital content at box 602, for example by providing the URL of the content. The operator may also specify the topic about the digital content in box 604. For example, the URL content provided in box 602 are related to devices or internet, and the operator can fill box 604 with “devices” and “internet.” The operator then presses or clicks button 606 for generating question and answers from the digital content provided in box 602. Boxes 608 and 610 shows two example question-answer pairs. The answer in box 608 is augmented with suggested reads including URL links to additional information. The answer in box 608 also includes a URL link for the source of the answer. The operator may select a question-answer pair by checking a corresponding checkbox for edit or approval.

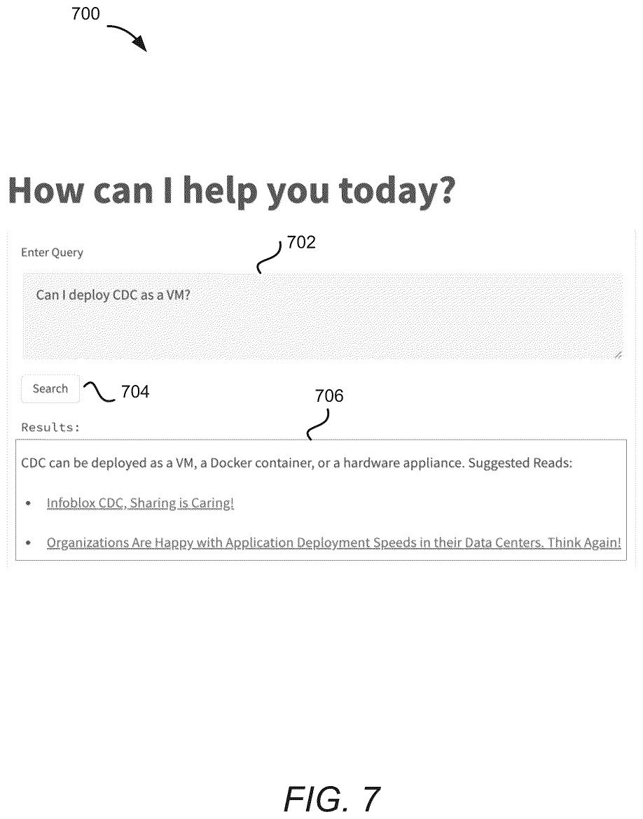

FIG. 7 depicts an example of a GUI 700 for responding to a user question, according to certain embodiments of the present disclosure. A visitor on an online platform can enter a user question or query in box 702. The visitor can press or click the “search” button 704. The search result (e.g., answer to the user question) provided by an online interaction server 102 is shown in box 706, which includes an answer and URL links for additional information.

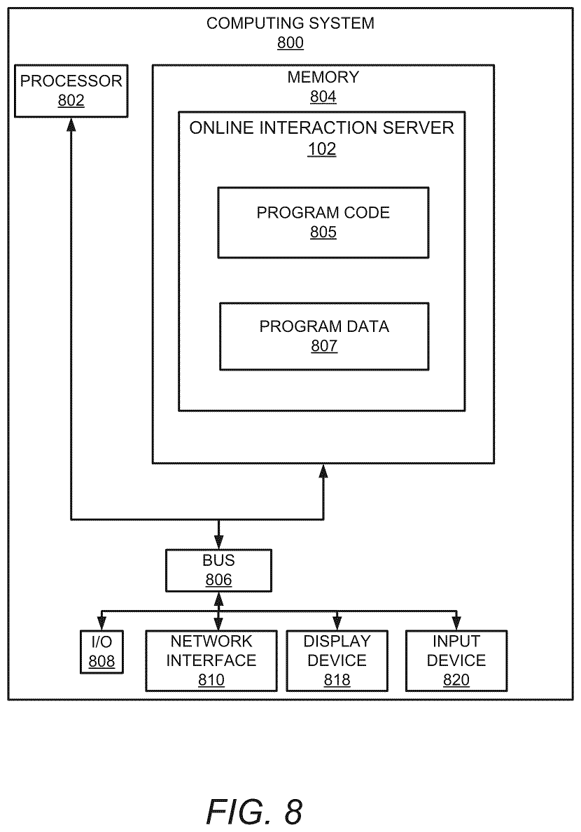

Any suitable computing system or group of computing systems can be used for performing the operations described herein. For example, FIG. 8 depicts an example of the computing system 800 for implementing certain embodiments of the present disclosure. The implementation of computing system 800 could be used to implement the online interaction server 102. In other embodiments, a single computing system 800 having devices similar to those depicted in FIG. 8 (e.g., a processor, a memory, etc.) combines the one or more operations depicted as separate systems in FIG. 1.

The depicted example of a computing system 800 includes a processor 802 communicatively coupled to one or more memory devices 804. The processor 802 executes computer-executable program code stored in a memory device 804, accesses information stored in the memory device 804, or both. Examples of the processor 802 include a microprocessor, an application-specific integrated circuit (“ASIC”), a field-programmable gate array (“FPGA”), or any other suitable processing device. The processor 802 can include any number of processing devices, including a single processing device.

A memory device 804 includes any suitable non-transitory computer-readable medium for storing program code 805, program data 807, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 800 executes program code 805 that configures the processor 802 to perform one or more of the operations described herein. Examples of the program code 805 include, in various embodiments, the application executed by question-answer generation module 104 for generating questions and answers from digital content provided by an online platform 120, an answer augmentation module 106 for augmenting a generated answer with additional information, a question matching module 108 for identifying a predefined question that best matches a user question, or other suitable applications that perform one or more operations described herein. The program code may be resident in the memory device 804 or any suitable computer-readable medium and may be executed by the processor 802 or any other suitable processor.

In some embodiments, one or more memory devices 804 stores program data 807 that includes one or more datasets and models described herein. Examples of these datasets include extracted images, feature vectors, aesthetic scores, processed object images, etc. In some embodiments, one or more of data sets, models, and functions are stored in the same memory device (e.g., one of the memory devices 804). In additional or alternative embodiments, one or more of the programs, data sets, models, and functions described herein are stored in different memory devices 804 accessible via a data network. One or more buses 806 are also included in the computing system 800. The buses 806 communicatively couples one or more components of a respective one of the computing system 800.

In some embodiments, the computing system 800 also includes a network interface device 810. The network interface device 810 includes any device or group of devices suitable for establishing a wired or wireless data connection to one or more data networks. Non-limiting examples of the network interface device 810 include an Ethernet network adapter, a modem, and/or the like. The computing system 800 is able to communicate with one or more other computing devices (e.g., a user computing device 134) via a data network using the network interface device 810.

The computing system 800 may also include the number of external or internal devices, an input device 820, a display device 818, or other input or output devices. For example, the computing system 800 is shown with one or more input/output (“I/O”) interfaces 808. An I/O interface 808 can receive input from input devices or provide output to output devices. An input device 820 can include any device or group of devices suitable for receiving visual, auditory, or other suitable input that controls or affects the operations of the processor 802. Non-limiting examples of the input device 820 include a touchscreen, a mouse, a keyboard, a microphone, a separate mobile computing device, etc. A display device 818 can include any device or group of devices suitable for providing visual, auditory, or other suitable sensory output. Non-limiting examples of the display device 818 include a touchscreen, a monitor, a speaker, a separate mobile computing device, etc.

Although FIG. 8 depicts the input device 820 and the display device 818 as being local to the computing device that executes the online interaction server 102, other implementations are possible. For instance, in some embodiments, one or more of the input device 820 and the display device 818 can include a remote client-computing device that communicates with the computing system 800 via the network interface device 810 using one or more data networks described herein.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

That which is claimed is:

1. A method performed by one or more processing devices, comprising:
accessing a set of digital content available at a set of designated network locations;
further training a pre-trained large language model (LLM) using the set of digital content to obtain a customized LLM;
generating a set of question-answer pairs based on the set of digital content using the customized LLM;
validating a plurality of question-answer pairs to generate a set of validated question-answer pairs, wherein validating a question-answer pair comprises determining that the answer in the question-answer pair is derived from the set of digital content; and
selecting a digital asset to augment the answer in a validated question-answer pair, wherein the digital asset is derived from the set of digital content and is selected based on a semantic similarity between the validated question-answer pair and the digital asset.

2. The method of claim 1, further comprising:
prior to generating the set of question-answer pairs, receiving a prompt; and
generating the set of question-answer pairs based on the prompt and the set of digital content using the customized LLM.

3. The method of claim 1, wherein determining that the answer in the question-answer pair is derived from the set of digital content comprises:
determining an entailment score for the answer in the question-answer pair using a textual entailment model, wherein the set of digital content is a premise and the answer in the question-answer pair is a hypothesis; and
including the question-answer pair in the set of validated question-answer pairs if the entailment score is equal to or greater than a threshold entailment score.

4. The method of claim 1, wherein selecting the digital asset to augment the answer in the validated question-answer pair comprises:
generating an embedding vector for each digital asset of a set of digital assets using an embedding model;
generating an embedding vector for the validated question-answer pair using the embedding model;
estimating a similarity score to measure a similarity between the embedding vector for the validated question-answer pair and the embedding vector for each digital asset;
ranking the set of digital assets based on respective similarity scores of the set of digital assets to generate a ranked list of digital assets; and
selecting the digital asset from the ranked list of digital assets based on the digital asset having a greater similarity score than other digital assets.

5. The method of claim 1, further comprising:
transmitting the set of validated question-answer pairs to a reviewer client device; and
receiving feedback from the reviewer client device to generate an updated set of validated question-answer pairs.

6. The method of claim 1, further comprising:
receiving a user question from a user computing device;
generating an embedding vector for the user question;
generating an embedding vector for each question in the set of validated question-answer pairs;
estimating a similarity score to measure a similarity between the embedding vector for the user question and the embedding vector for each question in the set of validated question-answer pairs;
determining that a question in a validated question-answer pair has a highest similarity score of all questions in the set of validated question-answer pairs;
determining whether the highest similarity score is equal to or greater than a predetermined threshold similarity score; and
in response to determining that the highest similarity score is equal to or greater than the predetermined threshold similarity score, causing the answer in the validated question-answer pair to be displayed on the user computing device along with the digital asset.

7. The method of claim 6, wherein the digital asset comprises a link to additional content relevant to the answer in the validated question-answer pair.

8. The method of claim 6, further comprising, in response to determining that the highest similarity score is less than the predetermined threshold similarity score, causing a message to be displayed on the user computing device indicating that a responsive answer to the user question is not found.

9. A system, comprising:
a memory component;
a processing device coupled to the memory component, the processing device to perform operations comprising:
receiving a user question via an online platform from a user computing device;
estimating a semantic similarity between the user question and each predefined question in a set of predefined question-answer pairs to generate a set of semantic similarity scores;
determining whether a highest semantic similarity score in the set of semantic similarity scores is equal to or greater than a threshold value;
causing a predefined answer paired with a predefined question corresponding to the highest semantic similarity score to be displayed on the user computing device;
selecting a digital asset from a set of digital assets using a semantic search algorithm to augment the answer; and
causing the digital asset to be displayed along with the answer on the user computing device.

10. The system of claim 9, wherein the set of predefined question and answers are generated based on a set of digital content specific to the online platform.

11. The system of claim 9, wherein estimating a semantic similarity between the user question and each predefined question in a set of predefined question-answer pairs to generate a set of semantic similarity scores comprises:
generating an embedding vector for the user question;
generating an embedding vector for each predefined question in the set of predefined question-answer pairs; and
estimating a semantic similarity score to measure a similarity between the embedding vector for the user question and the embedding vector for each predefined question in the set of predefined question-answer pairs.

12. The system of claim 9, wherein the processing device is to perform further operations comprising:
determining the highest semantic similarity score is less than the threshold value; and
causing a message to be displayed on the user computing device indicating that a responsive answer to the user question is not found.

13. The system of claim 9, wherein selecting a digital asset using a semantic search algorithm to augment the answer comprises:
generating an embedding vector for each digital asset of a set of digital assets using an embedding model;
generating an embedding vector for a predefined question-answer pair comprising the predefined question with the highest semantic similarity score and corresponding predefined answer using the embedding model;
estimating a similarity score to measure a similarity between the embedding vector for the predefined question-answer pair and the embedding vector for each digital asset using the semantic search algorithm;
ranking the set of digital assets based on respective similarity scores of the set of digital assets to generate a ranked list of digital assets; and
selecting the digital asset from the ranked list of digital assets based on the digital asset having a greater similarity score than other digital assets.

14. The system of claim 9, wherein the digital asset comprises a uniform resource locator (URL) link to additional content.

15. A non-transitory computer-readable medium storing executable instructions, which when executed by a processing device, cause the processing device to perform operations comprising:
accessing a set of digital content available at a set of designated network locations;
a step for generating a set of question-answer pairs based on the set of digital content;
validating a plurality of question-answer pairs to generate a set of validated question-answer pairs by determining that an answer in a question-answer pair is derived from the set of digital content; and
a step for selecting a digital asset to augment the answer in a validated question-answer pair based on a semantic similarity between the validated question-answer pair and the digital asset.

16. The non-transitory computer-readable medium of claim 15, wherein the set of designated network locations comprises one or more uniform resource locators (URLs).

17. The non-transitory computer-readable medium of claim 15, wherein determining that an answer in the question-answer pair is derived from the set of digital content comprises:
determining an entailment score for the answer in the question-answer pair using a textual entailment model, wherein the set of digital content is a premise and the answer in the question-answer pair is a hypothesis;
determining whether the entailment score is equal to or greater than a threshold entailment score; and
including the question-answer pair in the set of validated question-answer pairs in response to determining that the entailment score is equal to or greater than a threshold entailment score.

18. The non-transitory computer-readable medium of claim 17, wherein determining that an answer in the question-answer pair is derived from the set of digital content further comprises:
excluding the question-answer pair from the set of validated question-answer pairs in response to determining that the entailment score is less than a threshold entailment score.

19. The non-transitory computer-readable medium of claim 15, wherein the executable instructions, which when executed by a processing device, cause the processing device to perform further operations comprising:
receiving a user question from a user computing device;
estimating a semantic similarity between the user question and each question in the set of validated question-answer pairs to generate a set of semantic similarity scores;
determining that a question in a validated question-answer pair has a highest similarity score of all questions in the set of validated question-answer pairs;
determining whether the highest similarity score is equal to or greater than a predetermined threshold similarity score; and
in response to determining that the highest similarity score is equal to or greater than the predetermined threshold similarity score, causing the answer in the validated question-answer pair to be displayed on a user computing device along with the digital asset.

20. The non-transitory computer-readable medium of claim 19, wherein the executable instructions, which when executed by a processing device, cause the processing device to perform further operations comprising:
in response to determining that the highest similarity score is less than the predetermined threshold similarity score, causing a message to be displayed on the user computing device indicating that a responsive answer to the user question is not found.
